(19) United States
(12) Patent Application Publication
(10) Pub. No.: US 2014/0198370 A1
(43) Pub. Date: Jul. 17, 2014

(54) Solid Electro-chromic Stack Including Electro-chromic Nanoparticles and Methods of Forming the Same Using Layer-by-Layer Deposition

(71) Applicant: PIXELOPTICS, INC. (ESTATE OF), Wilmington, DE (US)

(72) Inventors: Anita Trajkovska-Broach, Christiansburg, VA (US); William Kokonaski, Gig Harbor, WA (US)

(73) Assignee: PIXELOPTICS, INC. (ESTATE OF), Wilmington, DE (US)

(21) Appl. No.: 14/157,170

(22) Filed: Jan. 16, 2014

Related U.S. Application Data
(60) Provisional application No. 61/753,517, filed on Jan. 17, 2013.

(51) Int. Cl. G02F 1/153

(52) U.S. Cl. CPC G02F 1/1533
USPC 359/265; 427/58

(57) ABSTRACT

A robust solid-state electro-chromic film stack including one or more electro-chromic layers composed of at least one bi-layer having a first and second layer. At least one of the first and second layer in each bi-layer includes electro-chromic nanoparticles formed of an electro-chromic material. A method of forming the robust solid-state electro-chromic film stack using a layer-by-layer deposition process is also provided.

### CROSS-REFERENCE TO RELATED APPLICATIONS

This application claims priority to the following U.S. Provisional Patent Application Ser. No. 61/753,517, titled “Solid electro-chromic stack applied to ophthalmic lens blank by layer-by-layer method”, filed Jan. 17, 2013, which is hereby incorporated by reference in its entirety.

### FIELD OF THE INVENTION

The present application relates to electro-chromic stacks including one or more bi-layers including electro-chromic nanoparticles formed of an electro-chromic material. More particularly, the present application is related to electro-chromic stacks including one or more bi-layers including electro-chromic nanoparticles formed of an electro-chromic material fabricated using a layer-by-layer deposition.

### BACKGROUND

Despite the large number of on-going research studies in the field of electro-chromic (EC) technologies, there is still a need for a compact and mechanically-robust solid-state electro-chromic film stack, which can be easily applied on existing lens blank or semi-finished blank (SFB) or other surfaces that need controllable transmission performance. In addition, such EC stack should operate under low voltage, and thus, not require large, heavy and aesthetically non-acceptable batteries. Furthermore, the variable-transmission EC stack should be fast-responding with a satisfactory dynamic range compared to the current available photochromic lenses or other switching technologies.

The EC stack should also survive all post-processing steps of SFB, such as edging into different lens shapes and grooving, which is not the case with non-solid EC devices utilizing liquid electrolytes.

### SUMMARY OF THE INVENTION

Some embodiments include a device having a first conductive layer, a second conductive layer, an electrolyte disposed between the first conductive layer and the second conductive layer, and an electro-chromic layer disposed between the first conductive layer and the second conductive layer including at least one bi-layer. The at least one bi-layer being disposed adjacent to the electrolyte and including a first layer and a second layer, and at least one of the first layer and the second layer of the bi-layer including electro-chromic nanoparticles formed of an electro-chromic material.

In some embodiments, the electro-chromic material is the only electro-chromic component of the nanoparticle.

In some embodiments, the at least one bi-layer includes no more than two electro-chromic materials. In some embodiments, each of the first layer and the second layer of the bi-layer includes no more than one electro-chromic material. In some embodiments, both the first layer and the second layer of the bi-layer include electro-chromic nanoparticles formed of an electro-chromic material.

In some embodiments, the at least one bi-layer is assembled using a layer-by-layer deposition method.

In some embodiments, the first layer or the second layer of the bi-layer includes a polymer/electro-chromic nanoparticle composite layer or an oligomer/electro-chromic nanoparticle composite layer. In some embodiments, the first layer or the second layer includes only nanoparticles formed of an electro-chromic inorganic material.

In some embodiments, the electro-chromic material is selected from the group comprising: WOx, NiO, Ir2O3, V2O5, MoO3, Fe^{III}₄[Ru^{II}(CN)₆]₃, and Fe^{III}[Fe^{III}Fe^{II}(CN)₆]₃. In some embodiments, the electro-chromic nanoparticles are formed of WOx. In some embodiments, X is between 2.6 and 2.98.

In some embodiments, the device includes only one electro-chromic material. In some embodiments, the device includes at least two electro-chromic materials.

In some embodiments, the first layer or the second layer of the bi-layer includes a continuous-phase electro-chromic material. In some embodiments, the electro-chromic nanoparticles are hydrogenated. In some embodiments, the electro-chromic nanoparticles are charged. In some embodiments, the electro-chromic nanoparticles are not charged.

In some embodiments, the first layer or the second layer of the bi-layer includes a polymer, oligomer, or a solvent. In some embodiments, the polymer is a polycation or a polyanion.

In some embodiments, the electrolyte is a solid-state or gel electrolyte. In some embodiments the device includes a substrate.

Some embodiments provide for a method including fabricating an electro-chromic device. The electro-chromic device including a substrate, a transparent conductive coating, and at least one electro-chromic layer including at least one bi-layer. The method further including fabricating the at least one bi-layer using layer-by-layer deposition by solution depositing a first layer, the first layer including a first component, solution depositing a second layer, the second layer including a second component, where the first component bonds with the second component, and where at least one of the first layer and the second layer of the bi-layer includes electro-chromic nanoparticles formed of an electro-chromic material.

In some embodiments, the method includes fabricating the electro-chromic device by providing the substrate, coating the substrate with the transparent conductive coating, preparing a first solution including the first component and solution depositing the first layer over the transparent conductive coating using the first solution. The method also includes preparing a second solution including the second component and solution depositing the second layer over the first layer using the second solution, and providing an electrolyte disposed over the at least one bi-layer.

In some embodiments, the first component is a charged component having a first charge and the second component is a charged component having a second charge opposite the first charge. In some embodiments, the first and second charged components are selected from the group including: polyanions, polycations, and nanoparticles. In some embodiments, the first component is hydrogenated electro-chromic nanoparticles and the second component is a polymer containing highly electronegative atoms. In some embodiments, the first component is a first polymer or oligomer and the second component is a second polymer or oligomer.

In some embodiments, the at least one bi-layer is formed by dipping.

In some embodiments, the first or second component is a polycation or a polyanion.

In some embodiments, the first solution or the second solution further includes at least one of a polymer, a binder, and a solvent.

In some embodiments, the method includes functionalizing a surface of the transparent conductive coating prior to forming the at least one bi-layer.

It will be appreciated that the various embodiments recited above with respect to the device and method can be combined in any combination, except where features are mutually exclusive.

### BRIEF DESCRIPTION OF THE DRAWINGS

The accompanying figures, which are incorporated herein, form part of the specification and illustrate embodiments described herein. Together with the description, the figures further serve to explain the principles of and to enable a person skilled in the relevant arts to make and use the invention.

FIGS. 1A and 1B show a schematic of an exemplary layer-by-layer assembly method where a film stack is built by electrostatic forces.

FIG. 2 shows the basic structure of an exemplary electro-chromic device according to one embodiment.

FIGS. 3A-F show various exemplary embodiments of bi-layers on a transparent substrate.

FIG. 4 illustrates a method of forming a bi-layer using a layer-by-layer assembly method according to one embodiment.

FIG. 5 illustrates a method of forming a bi-layer using a layer-by-layer assembly method according to one embodiment.

### DETAILED DESCRIPTION

This specification discloses one or more embodiments that incorporate the features of this invention. The disclosed embodiment(s) merely exemplify the invention. The scope of the invention is not limited to the disclosed embodiment(s). Multiple inventions may be described. The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to implement such feature, structure, or characteristic in connection with other embodiments whether or not explicitly described.

Some disclosed embodiments are related to a solid electro-chromic (EC) film stack that can be added to an existing lens blank or semi-finished lens blank using a layer-by-layer (LbL) assembly method. Among different nanofabrication methods, the LbL assembly method provides nanoscale control of a multilayer stack thickness and presents an ideal tool for precise tailoring the properties of electroactive (electro-chromic) films. Conventionally, LbL assembly is done by electrostatic deposition of polycations and polyanions, i.e. by alternately dipping the substrate into solutions of polycations and polyanions, which usually results in a linear film growth, and thus, the ultimate thickness being controlled by the number of bilayers deposited. LbL approaches, as described in some of the embodiments, incorporate not only dipping the substrate into polymer solutions, but also dipping into a variety of nanoparticles dispersions or nanoparticle-polymer composite solutions, thus allowing tailoring of the properties of electro-chromic film stacks. Furthermore, LbL assembly processes in the present application are not necessarily governed only by electrostatic forces, but can be also be governed by other complexation mechanisms, such as hydrogen bonding.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, an electro-chromic layer may be described as “disposed over” the substrate, even though there are various layers in between the electro-chromic layer and the substrate.

As used here the term “polymer” means a large molecule composed of many repeated sub-units, known monomers. As used herein, the term “oligomer” means a molecular complex composed of a few monomer units. For example, a dimer, trimer, and tetramer are oligomers composed of two, three, and four monomers, respectively.

As used herein the term “layer-by-layer assembly method” or “layer-by-layer deposition” means a thin-film fabrication method for forming a multi-layer structure. The method involves repeated, sequential exposure of one or more portions of a surface to one or more fluids (e.g., solutions, dispersions), each fluid containing a material to be formed on the surface. In some cases, one or more portions of a surface may be exposed, in an alternating manner, to fluids (e.g., solutions, dispersions) containing complimentarily function materials, thereby forming a multi-layered stack having alternating layers of complementarily functionalized materials. The thickness of a layer formed using layer-by-layer deposition is dependent on the properties of the fluid used to create the layer. Deposition time can also be a factor that dictates the final thickness of a layer formed using layer-by-layer deposition. Other factors such as the speed/rate of withdrawal of a surface from the fluid can also affect thickness of layers formed using layer-by-layer deposition.

As used herein the term “bi-layer” means two complementary layers, a first layer and a second layer. The first layer including a first component that bonds with a second component that is included in the second layer.

As used herein the terms “electro-chromic (EC) stack” and “electro-chromic layer” mean a multi-layer structure including at least one bi-layer having at least one electro-chromic material

As used herein the term “bond” means any physical or chemical attraction between two different entities (e.g. atoms, molecules, complexes, particles, ect.). A “bond” can include a hydrogen bond, an electrostatic bond, a covalent bond, an ionic bond, and the like.

As used herein the term “formed of an electro-chromic material” means that an entity, such as a nanoparticle, is made of an electro-chromic material. In other words, the core structure of the nanoparticle is an electro-chromic material. While the nanoparticle is made of an electro-chromic material, other components may be present on the nanoparticle. Other possible components include, but are not limited to, coatings, binders, ect.

As used herein the term “solution deposited” means depositing, coating, or forming a layer using one or more fluids. The fluids can include, but are not limited to, solutions, dispersions, emulsions, and slurries. The fluids can be deposited using various techniques including, but not limited to, dipping, spraying, spin coating, or other fluidic type coating methods.

As used herein the term “electro-chromic” means a substance that produces a significant change in color and/or transparency when it is subjected to an electric charge.

As used herein, “nanoparticle” means a particle of any shape (sphere, rod, plate, ect.) having an effective diameter (dimensions) measured in nanometers. Nanoparticles are 3-dimensional objects, and unless they are perfect spheres, they cannot be fully described by a single dimension such as a radius or diameter. Therefore, it is often convenient to define the particle size using the concept of equivalent spheres. In this case, the particle size is defined by the diameter of an equivalent sphere having the same volume or the same mass or the same specific area as the actual particle. Preferably, the nanoparticles are between 2 and 500 nanometers in size. More preferably, the nanoparticles are between 50 and 200 nanometers in size.

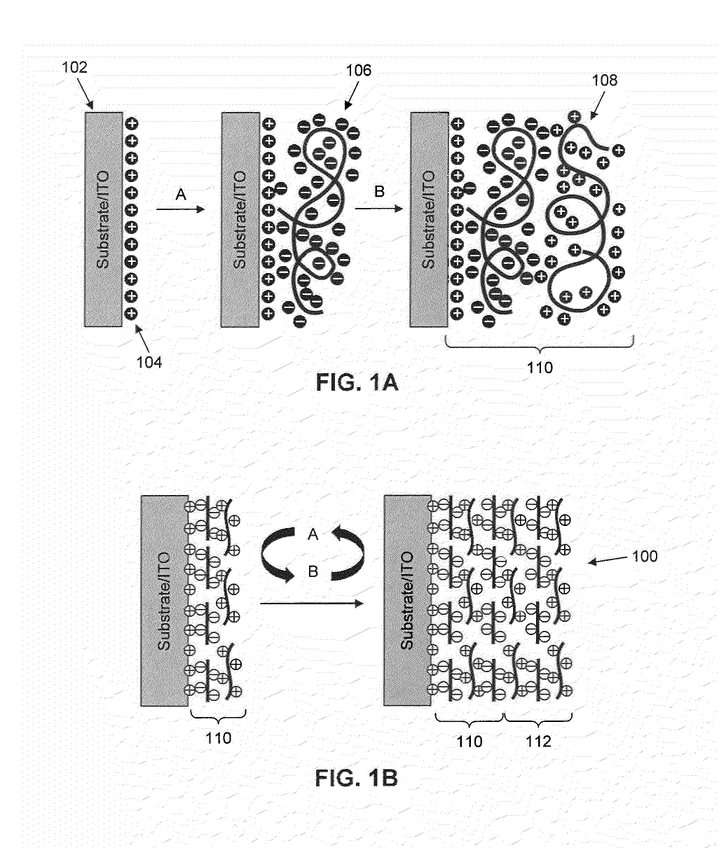

FIGS. 1A and B are a schematic of a LbL assembly method where a multi-layer film stack 100 is built by electrostatic forces. First, a substrate 102 coated with ITO is functionalized to create a positively charged surface 104. Once charged surface 104 is formed, a negatively charged species 106 is disposed over charged surface 104. Next, a positively charged species 108 is disposed over negatively charged species 106. Positively charged species 108 bonds with negatively charged species 106 thereby forming a bi-layer 110. As shown in FIG. 1B, this process can be repeated to form a second bi-layer 112. Furthermore, this process can be repeated any number of times to form a multi-layer film stack including any number of bi-layers (not shown). It is appreciated that the charges of the individual layers may be inverted. In other words, the charged surface may be negatively charged, a positively charged species may be disposed over the negatively charged surface and so on.

The following disclosure is directed toward a LbL assembly method for depositing an EC film stack (i.e. EC layer) for use in an electro-chromic device. For example, an EC stack (EC layer) can be deposited on a SFB using a LbL assembly method. The EC stack deposited on a SFB using a LbL assembly method can be further processed and shaped into any shape required by various eyeglass frames. Moreover, the EC stack deposited by a LbL technique can be applied not only on ophthalmic lens surfaces, but also to any surface that will require controllable and variable transmission, such as architectural windows, walls and roofs, shades, blinds, car windows and sunroofs, car mirrors, helmets, etc. Preferred embodiment of ophthalmic lens surfaces include, but are not limited to, prescription and non-prescription eyeglass lenses.

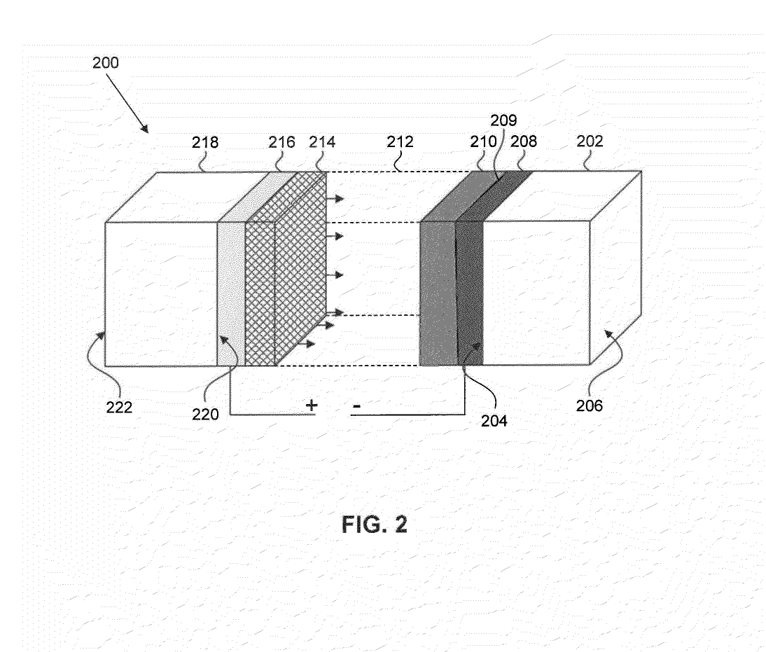

FIG. 2 presents a schematic of the basic structure of an electro-chromic (EC) device 200 according to one embodiment. EC device 200 includes a first substrate 202 having a first surface 204 and a second surface 206. Examples of substrates include, but are not limited to, glass or plastic substrates, such as poly(ethylene terephthalate) (PET), poly(ethylene, 2,6-naphthalate) (PEN), polycarbonate (PC), polyether ether ketone (PEEK), poly(ether sulfone) (PES), polycyclic olefin, etc. The substrate may be transparent. The substrate may be rigid or flexible.

A first transparent conductor 208 is disposed over first surface 204. Examples of transparent conductors include, but are not limited to, indium tin oxide (ITO), fluorine doped tin oxide (FTO), antimony doped tin oxide (ATO), aluminum-doped zinc oxide (AZO), zinc oxide (ZnO), conjugated polymers, and a silver nano-wire gird. An exterior surface 209 of first transparent conductor 208 may be functionalized to have a positive or negative charge. For example, first transparent conductor 208 can be cleaned with polar solvents, can be activated with abrasives or silanes, or can be plasma-treated.

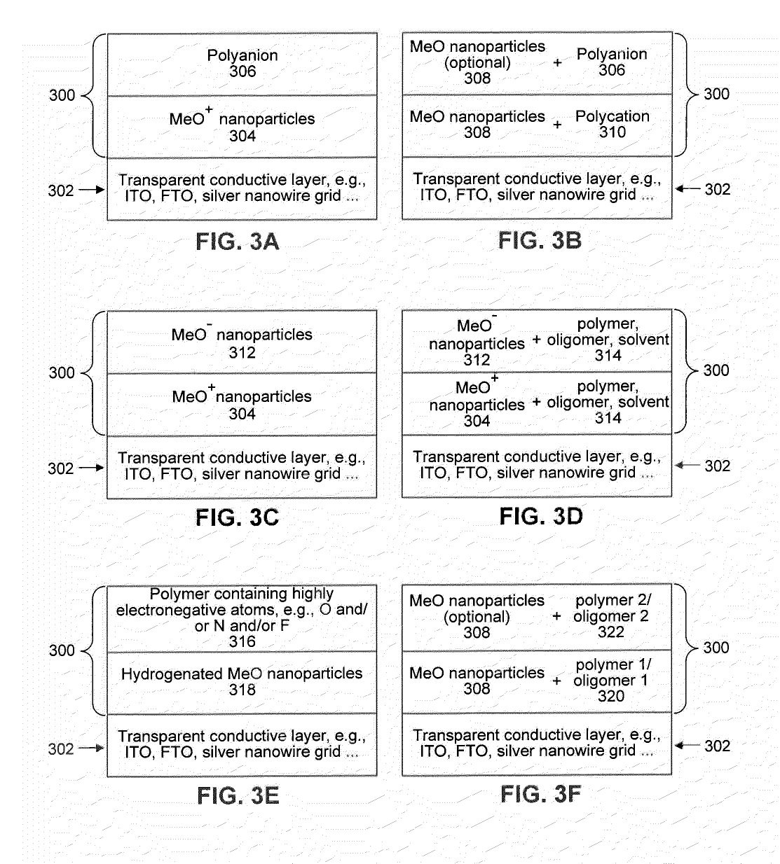

An EC layer 210 is disposed over exterior surface 209 of first transparent conductor 208 and includes at least one electro-active material. EC layer 210 is composed of at least one bi-layer including a first and second layer (see for example, FIG. 3A, described in detail below). Optionally, one or more ion conductive layers (not shown) may be disposed over EC layer 210. Disposed over EC layer 210 and optional ion conductive layer(s) is an electrolyte 212.

In some embodiments, the electrolyte can be a solid-state electrolyte or gel electrolyte. Some embodiments include a solid electrolyte made of a polar polymer matrix, for example, but not limited to, polyvinylidene fluoride (PVDF), succinonitrile, or poly(ethylene oxide) (PEO) with salts (Li-salts, K-salts, Na-salts) and/or ionic liquids. Such an electrolyte can be applied by spin-coating or spraying from a solution. In the case of gel electrolytes, they can be applied as a liquid by dip-coating or spray coating or spin-coating methods, and then, “solidified” by UV exposure, thermal heating, or air exposure, for example.

On the side of electrolyte 212 opposite first substrate 202 are an optional layer 214 and a second transparent conductor 216. Optional layer 214 includes at least one of an EC layer and one or more ion conductive layers. Second transparent conductor 216 is similar to or identical to first transparent conductor 208 and may also be functionalized. Some of the embodiments in the present application relate to an EC device containing only one substrate, and all layers (e.g. 208, 210, 212) being coated subsequently on one substrate. In other embodiments, the EC device can include a second substrate 218 including a first surface 220 and a second surface 222.

The electro-active material present in the EC layer 210 causes a reversible color/transmission change when a charge is applied between first transparent conductor 208 and second transparent conductor 214. Electro-active materials that can be utilized include, but are not limited to, electro-chromic nanoparticles formed of an electro-chromic metal oxide (MeO), such as, but not limited to, WOx, NiO, Ir₂O₃, V₂O₅, MoO₃. Electro-chromic nanoparticles formed of an inorganic non-oxide electro-chromic material, such as, but not limited to, metal hexacyanoferrates (e.g. Fe^{III}₄[R^{II}(CN)₆]₃, Fe^{III}[Fe^{III}Fe^{II}(CN)₆]₃). Additional electro-chromic materials include, but are not limited to, viologens and conjugated polymers (e.g. poly(3,4-ethylenedioxythiophene) (PEDOT)-derivatives). The nanoparticles provide an electro-active material having a high specific surface area. The use of high specific surface area electro-chromic materials results in rapid switching times. High surface area electro-active materials also result in increased color/transmission change in thin layers. For example, a layer composed of an electro-active material having a higher specific surface area will have a more significant color/transmission change when a charge is applied versus a layer having the same thickness and lower specific surface area electro-active material.

In some embodiments, the electro-chromic material used to make the electro-chromic nanoparticles is the only electro-chromic component of the nanoparticle.

Preferably, the nanoparticles are between 2 and 500 nanometers in size. More preferably, the nanoparticles are between 50 and 200 nanometers in size.

In a preferred embodiment, the electro-chromic nanoparticles are WOₓ nanoparticles obtained from Nanograde Ltd. (Switzerland) or nanoComposix (USA). Preferably, X is less than 3, more preferably, X equals 2.6-2.98, and more preferably X equals 2.7-2.9. WOₓ nanoparticles having an oxygen deficiency (i.e. X<3) is preferred because it is believed that oxygen deficiency in WOₓ materials results in a large electro-chromic effect when a charge is applied. While WOₓ having an oxygen deficiency has been specifically described, it is appreciated that other electro-chromic nanoparticle materials, i.e. NiO, Ir₂O₃, V₂O₅, MoO₃, may also have oxygen deficiencies that increase the electro-chromic effect of the material.

In another embodiment, EC layer 210 and/or a layer within EC layer 210 can comprise two types of EC materials, the colors of which can be additive or complementary. For example, EC layer 210 can incorporate MeO EC nanoparticles and non-oxide EC nanoparticles, MeO EC nanoparticles and a conjugated polymer, MeO EC nanoparticles and viologen, or a conjugated polymer and non-oxide EC nanoparticles. In some embodiments, the EC layer includes at least one layer of continuous-phase EC materials.

EC layer 210 in the present application contains at least one bi-layer 300 (see, for example, FIGS. 3A-F). Each bi-layer 300 includes a first layer and a second layer. At least one of the first layer and the second layer in each bi-layer includes electro-chromic nanoparticles formed of an electro-chromic material. Each bi-layer 300 constituting EC layer 210 may be the same or may be different. When both the first and second layer of the bi-layer include electro-chromic nanoparticles, the type of nanoparticles present in the first and second layer may be the same or different. In some embodiments, each bi-layer in EC layer 210 includes no more than two electro-chromic materials. In some embodiments, the first and second layer of each bi-layer in EC layer 210 includes no more than one electro-chromic material. FIGS. 3A-F illustrate various non-limiting examples of bi-layers 300 that can be used to create electro-chromic (EC) layer 210. Each bi-layer 300 in FIGS. 3A-F is disposed over a substrate 302 that is similar to substrate 202 in FIG. 2.

FIG. 3A illustrates a bi-layer 300 that includes a first layer composed of positively charged electro-chromic metal oxide (MeO) nanoparticles 304 and a second layer composed of a polyanion 306. The positively charged electro-chromic MeO nanoparticles 304 bond with polyanion 306 thereby forming a mechanically robust bilayer 300. It is appreciated that the position and/or charge of the layers in bi-layer 300 may be inverted. For example, the first layer in FIG. 3A may be composed of negatively charged electro-chromic MeO nanoparticles and the second layer may be composed of a polycation.

FIG. 3B illustrates a bi-layer 300 that includes a first layer composed of a mixture of uncharged electro-chromic metal oxide nanoparticles 308 and a polycation 310 and a second layer composed of a mixture of uncharged electro-chromic metal oxide nanoparticles 308 and a polyanion 306. Polycation 306 and polycation 308 bond with each other to form bi-layer 300. It is appreciated that the position of polyanion 306 and polycation 308 in FIG. 3B can be inverted. Furthermore, as indicated in FIG. 3B each layer in bi-layer 300 does not have to have MeO nanoparticles. Since the nanoparticles in FIG. 3B are not required to create a bond between the first and second layer (like in FIG. 3A) both layers do not necessarily have MeO nanoparticles.

FIG. 3C illustrates a bi-layer 300 that includes a first layer composed of positively charged electro-chromic metal oxide nanoparticles 304 and a second layer composed of negatively charged electro-chromic metal oxide nanoparticles 312. In FIG. 3C, positively charged MeO nanoparticles 304 bond with negatively charged MeO nanoparticles 312 to create a robust bi-layer 300. It is appreciated that the position/charge of the first and second layer in FIG. 3C could be inverted.

FIG. 3D illustrates a bi-layer 300 that includes a first layer composed of a mixture of positively charged electro-chromic metal oxide nanoparticles 304 and a polymer, oligomer, and/or solvent 314 and a second layer composed of a mixture of negatively charged electro-chromic metal oxide nanoparticles 312 and a polymer, oligomer, and/or solvent 314. Similar to FIG. 3C, positively charged MeO nanoparticles 304 bond with negatively charged MeO nanoparticles 312 to form bi-layer 300. It is appreciated that the charge of the nanoparticles in the first and second layer of FIG. 3D may be inverted. Examples of polymers and oligomers that may be utilized include, but are not limited to, PEO-, acrylate-, methacrylate-, PVDF- oligomers or polymers, and copolymers or mixtures thereof. Solvents that may be utilized include, but are not limited to, organic solvents and water. Preferably, the first layer and the second layer include only a polymer and/or oligomer with the solvent completely evaporated.

FIG. 3E illustrates a bi-layer 300 that includes a first layer composed of hydrogenated electro-chromic metal oxide nanoparticles 318 and a second layer composed of a polymer containing highly electronegative atoms 316. In FIG. 3E, hydrogenated electro-chromic MeO nanoparticles 318 in the first layer bond with the highly electronegative atoms present in the second layer thereby forming bi-layer 300. It is appreciated that the position of the layers in FIG. 3E may be inverted.

Examples of polymers with highly electronegative atoms that can be utilized in the embodiment shown in FIG. 3F include polymers that contain F, N, or O atoms. Polymers that contain F, N, or O atoms include, but are not limited to: poly(carbazole), poly(ethylene), poly(ethylene oxide), poly(propylene oxide), poly vinyl alcohol, poly(pyridine), polyacetonitrile, polybenzonitrile, fluorocarbon polymers such as tetrafluoroethylene and perfluorocarbons, nylon, cellulose polymers, ect.

FIG. 3F illustrates a bi-layer 300 that includes a first layer composed of a mixture of uncharged electro-chromic metal oxide nanoparticles 308 and a first polymer/oligomer 320 and a second layer composed of a mixture of uncharged electro-chromic metal oxide nanoparticles 308 and a second polymer/oligomer 322. In the embodiment shown in FIG. 3F the first polymer/oligomer 320 bonds with the second polymer/oligomer 322 to form bi-layer 300. The bond between first polymer/oligomer 320 and second polymer/oligomer 322 may be a hydrogen bond or an electrostatic bond. Similar to the embodiment shown in FIG. 3B, each layer in bi-layer 300 does not have to have MeO nanoparticles because the nanoparticles are not required to create a bond between the first and second layer. Examples of polymers and oligomers that may be utilized include, but are not limited to, PEO-, acrylate-, methacrylate-, PVDF-oligomers or polymers, and copolymers or mixtures thereof. Solvents that may be utilized include, but are not limited to, organic solvents and water.

The exemplary embodiments of bi-layers 300 shown in FIGS. 3A-F may all be fabricated using a layer-by-layer (LbL) assembly method. LbL assembly methods are inexpensive, easily reproducible, and easy to scale up for large volume processing and manufacturing. Additionally, LbL assembly methods provide for precise control of layer thickness. Layers formed using LbL assembly methods can be formed by, for example, dipping, spin coating, spraying, or other fluidic type coating methods. The thickness of layers including electro-chromic nanoparticles is preferably between 2 nm and 500 nm. The thickness of layers not including nanoparticles, ex. polymeric layers, is preferably between 5 angstroms (Å) and 500 nm.

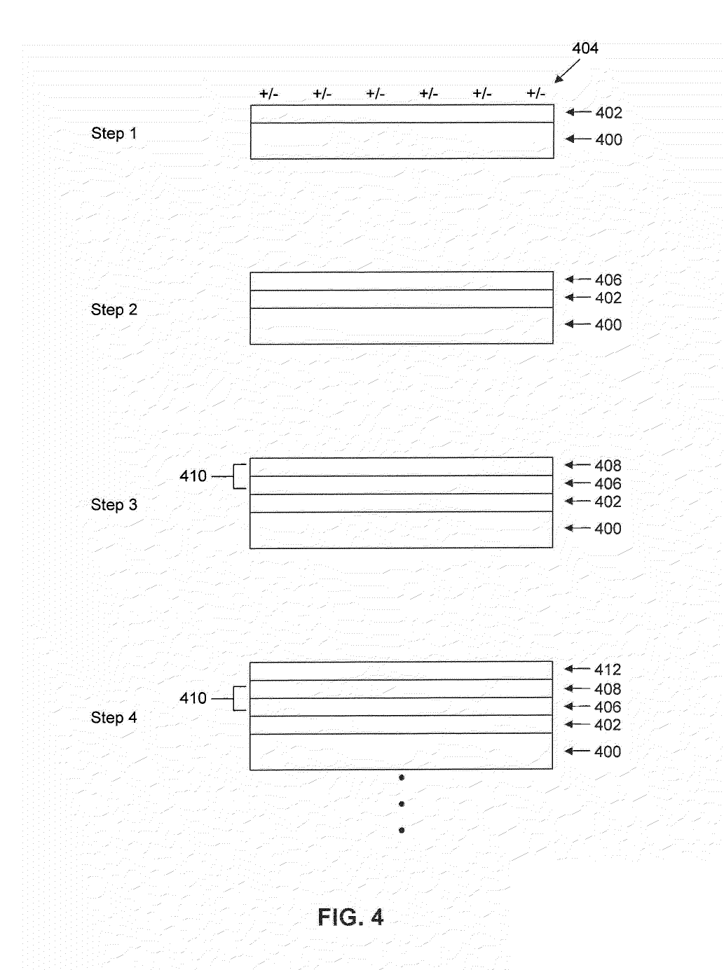

The method of forming a bi-layer 410 using an LbL assembly method will now be described in reference to FIG. 4. A substrate 400 is provided having a transparent conductor 402 disposed on one surface of substrate 400. In step 1, a surface of transparent conductor 402 may be functionalized to impart a positive or negative charge 404 thereon. Functionalization of transparent conductor 402 can create a robust bond between transparent conductor 402 and the first layer 406 that is solution deposited using a first solution in step 2. First layer 406 solution deposited in step 2 contains a first component. The first component can be selected from, but is not limited to nanoparticles, polyions, polymers, or oligomers. In step 3, after first layer 406 is solution deposited, a second layer 408 is solution deposited over first layer 406 using a second solution. Second layer 408 contains a second component that bonds with the first component present in first layer 406. Like the first component, the second component can be selected from, but is not limited to nanoparticles, polyions, polymers, or oligomers. The deposition of second layer 408 in step 3 results in the formation of bi-layer 410.

Steps 2 and 3 can be repeated any number of times to form any number of bi-layers 410. For example, as shown in step 4, an additional first layer 412 is solution deposited over second layer 408. Additional first layer 412 includes a component, which may or may not be the same as the first component in first layer 406, that bonds with the second component in second layer 408. Subsequently, an additional second layer (not shown) can be solution deposited over first additional layer 412, thereby forming a second bi-layer (not shown).

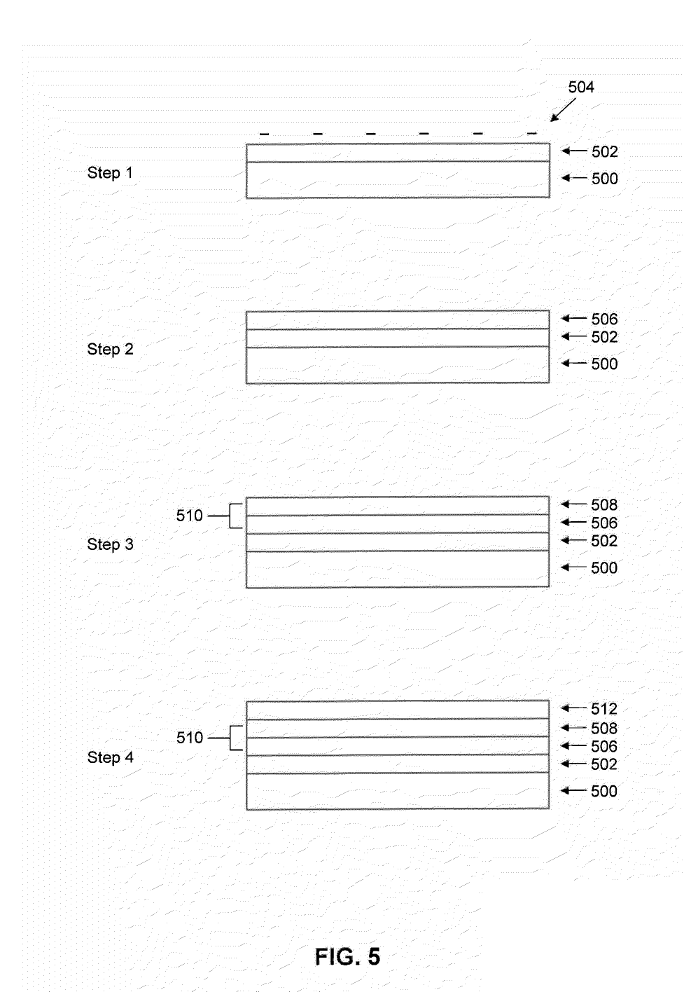

The layer-by-layer assembly method shown in FIG. 4 can be used to form any of the bi-layers 300 described above in FIGS. 3A-F. An exemplary method of forming bi-layer 510, similar to the embodiment shown in FIG. 3A will not be described in detail with reference to FIG. 5.

In step 1, a substrate 500 is provided having a transparent conductor 502 disposed on one surface of substrate 500. A surface of transparent conductor 502 is functionalized to impart a negative charge 504 thereon. In step 2, a first layer 506 is solution deposited using a first solution including positively charged electro-chromic nanoparticles formed of an electro-chromic material. The first solution may contain a suspension of electro-chromic MeO nanoparticles with appropriate pH and ionic strength. In addition to the MeO nanoparticles, the solution may contain other additives, such as binders, highly polar solvents, water, etc. The positively charged electro-chromic nanoparticles in first layer 506 bond with negative charge 504 present on the surface of transparent conductor 502. The thickness of first layer 506 is determined by the concentration of the first solution and the application parameters, e.g. the dipping rate of immersing and withdrawing substrate 500 and transparent conductor 502 during step 2.

In step 3, a second layer 508 is solution deposited over first layer 506 using a second solution containing a polyanion, such as polyacrylic acid (PAA), poly(sodium styrene sulfonate) (PSS), or Nafion. The polyanion present in the second solution bonds with the positively charged electro-chromic nanoparticles in first layer 506. The deposition of second layer 508 in step 3 results in the formation of bi-layer 510. Bi-layers fabricated in this way layers will result a mechanically-robust bi-layer bonded by electro-static forces.

Steps 2 and 3 can be repeated any number of times to form any number of bi-layers 510. For example, as shown in step 4, an additional first layer 512 is solution deposited. Similar to first layer 506, additional first layer 512 includes positively charged electro-chromic nanoparticles formed of an electro-active material. The positively charged electro-chromic nanoparticles in additional layer 512 bond with the polyanion present in second layer 508. Subsequently, an additional second layer (not shown) including a polyanion can be solution deposited over first additional layer 412, thereby forming a second bi-layer (not shown).

It is appreciated that the charge of functionalized surface 504, first layer 506, second layer 508, and additional layer 512 can be reversed. For example, in cases when the MeO nanoparticles in first layer 506 are negatively charged, polycations, such as polyethylenimine (PEI) can be applied as second layer 508.

In other embodiment, a robust multi-layer stack can be built with, for example, a PEO matrix with dispersed MeO nanoparticles, where the individual sublayers are bonded together by hydrogen-bonding forces. Depending on the molecular weight of the PEO, it can be used as a binder or as a matrix in which MeO nanoparticles are dispersed. For example, either polymer/oligomer 320 and/or 322 in FIG. 3F may be PEO.

In another embodiment, not all layers are applied by LbL methods, but some of them can be applied by one or combination of the following methods—ink-jet printing, traditional spraying methods, traditional spin-coating, etc.

In some embodiments, the EC stack shows switching times (bleached-to-colored-state and colored-to-bleached state) of less than 10 seconds. In some embodiments, the EC stack shows average transmission change greater than 65% in the visible spectral range. In some embodiments, the EC stack shows variable transmission when an external voltage of less than 3V is applied. In some embodiments, the EC stack has a coloration efficiency greater than 100 cm²/C. In some embodiments, the EC stack performs ca. 25,000 switching cycles without deterioration of optical performances greater than 10%. Other values for these parameters may also be characteristics of the EC stack.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the, hardware, methods and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

The breadth and scope of the invention should not be limited by any of the above-described exemplary embodiments, but should be defined only in accordance with the following claims and their equivalents.

What is claimed is:

1. A device comprising:
a first conductive layer and a second conductive layer;
an electrolyte disposed between the first conductive layer and the second conductive layer; and
an electro-chromic layer disposed between the first conductive layer and the second conductive layer comprising:
at least one bi-layer disposed adjacent to the electrolyte, the at least one bi-layer comprising a first layer and a second layer;
wherein at least one of the first layer and the second layer of the bi-layer includes electro-chromic nanoparticles formed of an electro-chromic material.

2. The device of claim 1, wherein the electro-chromic material is the only electro-chromic component of the nanoparticle.

3. The device of claim 1, wherein the at least one bi-layer includes no more than two electro-chromic materials.

4. The device of claim 1, wherein each of the first layer and the second layer of the bi-layer includes no more than one electro-chromic material.

5. The device of claim 1, wherein both the first layer and the second layer of the bi-layer includes electro-chromic nanoparticles formed of an electro-chromic material.

6. The device of claim 1, wherein at least one bi-layer is assembled using a layer-by-layer deposition method.

7. The device of claim 1, wherein the first layer or the second layer includes only nanoparticles formed of an electro-chromic inorganic material.

8. The device of claim 1, comprising only one electro-chromic material.

9. The device of claim 1, comprising a least two electro-chromic materials.

10. The device of claim 1, wherein the electro-chromic nanoparticles are hydrogenated.

11. A method comprising:
fabricating an electro-chromic device, the electro-chromic device comprising a substrate, a transparent conductive coating, and at least one electro-chromic layer comprising at least one bi-layer;
fabricating the at least one bi-layer by layer-by-layer deposition including:
solution depositing a first layer, the first layer including a first component;
solution depositing a second layer, the second layer including a second component;
wherein the first component bonds with the second component;
wherein at least one of the first layer and the second layer of the bi-layer includes electro-chromic nanoparticles formed of an electro-chromic material.

12. The method of claim 11, wherein the electro-chromic material is the only electro-chromic component of the nanoparticle.

13. The method of claim 11, wherein the at least one bi-layer includes no more than two electro-chromic materials.

14. The method of claim 11, wherein each of the first layer and the second layer of the bi-layer includes no more than one electro-chromic material.

15. The method of claim 11, wherein both the first layer and the second layer of the bi-layer includes electro-chromic nanoparticles formed of an electro-chromic material.

16. The method of claim 11, comprising fabricating the electro-chromic device by:
providing the substrate;
coating the substrate with the transparent conductive coating;
preparing a first solution including the first component and solution depositing the first layer over the transparent conductive coating using the first solution;
preparing a second solution including the second component and solution depositing the second layer over the first layer using the second solution; and
providing an electrolyte disposed over the at least one bi-layer.

17. The method of claim 11, wherein the first component is a charged component having a first charge and the second component is a charged component having a second charge opposite the first charge.

18. The method of claim 11, wherein the first component is hydrogenated electro-chromic nanoparticles and the second component is a polymer containing highly electronegative atoms.

19. The method of claim 11, wherein the first component is a first polymer or oligomer and the second component is a second polymer or oligomer.

20. The method of claim 11, wherein the at least one bi-layer is formed by dipping.
